(19) United States
(12) Patent Application Publication
(10) Pub. No.: US 2026/0087613 A1
(43) Pub. Date: Mar. 26, 2026

(54) SUBSTRATE MEASUREMENT METHOD

(71) Applicant: SAMSUNG ELECTRONICS CO., LTD., Suwon-si (KR)

(72) Inventors: Kwang-Eun KIM, Suwon-si (KR); Sewon KIM, Suwon-si (KR); Seo Young PARK, Suwon-si (KR); Jeongho AHN, Suwon-si (KR); Sungeun LEE, Suwon-si (KR)

(73) Assignee: SAMSUNG ELECTRONICS CO., LTD., Suwon-si (KR)

(21) Appl. No.: 19/069,757

(22) Filed: Mar. 4, 2025

(30) Foreign Application Priority Data
Sep. 20, 2024 (KR) 10-2024-0127753

(51) Int. Cl. G06T 7/00

(52) U.S. Cl. CPC G06T 7/001; G06T 2207/10061; G06T 2207/20048; G06T 2207/30148

(57) ABSTRACT

Provided is a substrate measurement method including acquiring a first measurement image corresponding to a first measurement area on a substrate, acquiring a reference image corresponding to the first measurement image, extracting phase information based on the first measurement image, extracting amplitude information based on the reference image, generating a first reconstructed image based on the phase information and the amplitude information, and determining location information of the first measurement area based on the first reconstructed image.

### CROSS-REFERENCE TO RELATED APPLICATION

This application claims priority to Korean Patent Application No. 10-2024-0127753, filed in the Korean Intellectual Property Office on Sep. 20, 2024, the disclosure of which is incorporated herein in its entirety by reference.

### BACKGROUND

Embodiments of the present disclosure relate to a substrate measurement method using a measurement device.

In order to accurately measure various microstructures or circuit patterns formed on a substrate during a semiconductor manufacturing process, precise coordinate correction may be required. In particular, in pattern measurement using an electron microscope, an alignment key may be used to correct a measurement coordinate, and die mapping of a wafer may be performed. However, in a case where a signal quality of a measurement image deteriorates due to a state of a surface of a substrate, it is difficult to recognize a pattern of the alignment key, and this may cause a problem in correcting an alignment error.

The above description is intended to enhance understanding of the background of the present disclosure, and may include description that is not included in a technique in the related art.

### SUMMARY

One or more embodiments provide a substrate measurement method for solving the above problems.

According to an aspect of one or more embodiments, there is provided a substrate measurement method including acquiring a first measurement image corresponding to a first measurement area on a substrate, acquiring a reference image corresponding to the first measurement image, extracting phase information based on the first measurement image, extracting amplitude information based on the reference image, generating a first reconstructed image based on the phase information and the amplitude information, and determining location information of the first measurement area based on the first reconstructed image.

According to another aspect of one or more embodiments, there is provided a substrate measurement method including acquiring a measurement image corresponding to a measurement area on a substrate by a measurement device, determining whether a pattern of the measurement area is recognizable based on the measurement image, performing an image correction based on a determination that the pattern of the measurement area is not recognizable, and determining location information of the measurement area based on a reconstructed image acquired by performing the image correction, wherein the performing the image correction includes acquiring a reference image corresponding to the measurement image, extracting phase information based on the measurement image, extracting amplitude information based on the reference image, and generating the reconstructed image based on the phase information and the amplitude information.

According to still another aspect of one or more embodiments, there is provided a substrate measurement method including acquiring a preliminary alignment mark image by capturing an alignment mark on a substrate using an optical microscope, determining a measurement location of an electron microscope based on the preliminary alignment mark image, acquiring a measurement image for the alignment mark by capturing the alignment mark using the electron microscope based on the determined measurement location of the electron microscope, determining whether a pattern of the alignment mark is recognizable based on the measurement image, performing an image correction based on a determination that the pattern of the alignment mark is not recognizable, and determining location information of the alignment mark based on a reconstructed image acquired by performing the image correction, wherein the performing the image correction including acquiring a reference image corresponding to the measurement image by the electron microscope, extracting phase information from frequency domain information of the measurement image, extracting amplitude information from frequency domain information of the reference image, and generating the reconstructed image based on the phase information and the amplitude information.

### BRIEF DESCRIPTION OF DRAWINGS

Embodiments will be more clearly understood from the following detailed description taken in conjunction with the accompanying drawings in which:

FIG. 1 is a schematic diagram illustrating a measurement device according to one or more embodiments;

FIG. 2 is a schematic perspective view of a measurement platform in FIG. 1.

FIG. 3 is a block diagram illustrating a configuration of a processor of the measurement device according to one or more embodiments;

FIG. 4 is a schematic plan view of a substrate in FIG. 1.

FIG. 5 is a schematic plan view of a reference sample in FIG. 1.

FIG. 6 is an example of a reference image according to one or more embodiments;

FIG. 7 is an example of a reference image according to one or more embodiments;

FIG. 8 is a flowchart illustrating an example of a substrate measurement method according to one or more embodiments;

FIG. 9 is a flowchart illustrating an example of a substrate measurement method according to one or more embodiments;

FIG. 10 is a diagram for explaining a method of generating a reconstructed image according to one or more embodiments;

FIG. 11 is a diagram illustrating examples of frequency domains for each of a measurement image, a reference image, and a reconstructed image;

FIG. 12 is a diagram for explaining a method for generating a reconstructed image according to one or more embodiments;

FIG. 13 is a diagram for explaining a method of generating a reconstructed image according to one or more embodiments;

FIG. 14 is a schematic diagram illustrating a measurement device according to one or more embodiments;

FIG. 15 is a schematic diagram illustrating a measurement device according to one or more embodiments; and

FIG. 16 is a flowchart illustrating an example of a substrate measurement method according to one or more embodiments.

### DETAILED DESCRIPTION

Hereinafter, one or more embodiments of the present disclosure will be described in detail with reference to the accompanying drawings. The same reference numerals are used for the same components in the drawings, and a repeated description thereof will be omitted.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

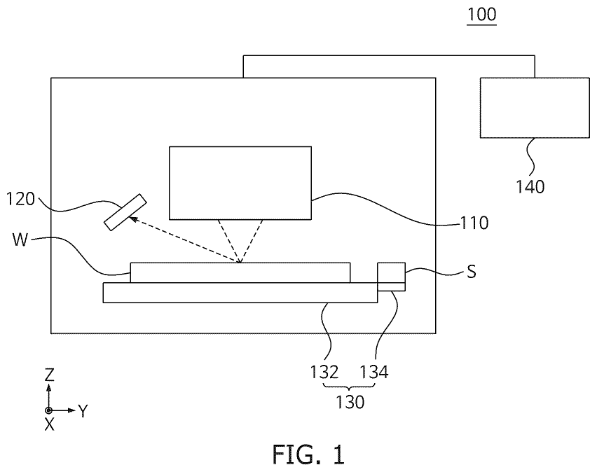

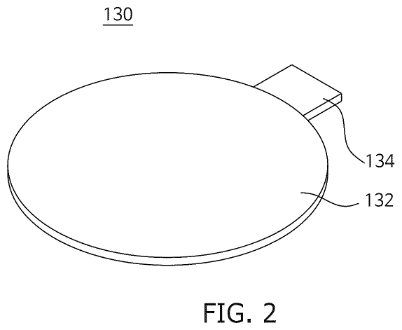

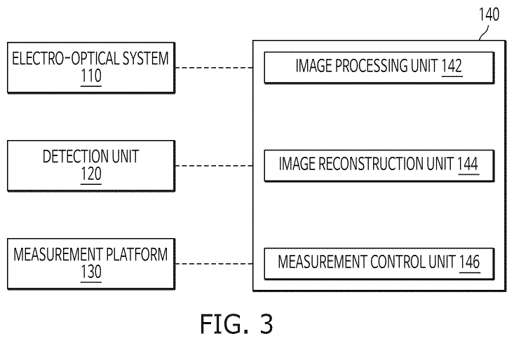

FIG. 1 is a schematic diagram illustrating a measurement device 100 according to one or more embodiments. FIG. 2 is a schematic perspective view of a measurement platform 130 in FIG. 1. FIG. 3 is a block diagram illustrating a configuration of a processor 140 according to one or more embodiments.

Referring to FIGS. 1 and 2, a measurement device 100 may be configured to measure a substrate W. According to one or more embodiments, the measurement device 100 may measure a substrate W on which a process of manufacturing a semiconductor device is performed in a scanning manner. According to one or more embodiments, the measurement device 100 may acquire topographical information of the substrate W, morphological information of the substrate W, such as shapes and sizes of particles included in the substrate W, or crystallographic information of the substrate W, such as an arrangement state of atoms in the substrate W by measuring the substrate W. For example, the substrate W may be a wafer. For example, the substrate W may be a silicon (Si) wafer. The substrate W may be a wafer including at least one of gallium arsenide (GaAs) and silicon carbide (SiC). The substrate W may be a glass substrate. However, embodiments are not limited thereto.

In one or more embodiments, the measurement device 100 may be an electron microscope. For example, the measurement device 100 may be a scanning electron microscope (SEM). However, embodiments are not limited thereto. The measurement device 100 may be a transmission electron microscope (TEM) or an electron beam inspection apparatus. In one or more other embodiments, the measurement device 100 may include an optical microscope. For example, the measurement device 100 may be an optical microscope. In another example, the measurement device 100 may include both an electron microscope and an optical microscope.

According to one or more embodiments, the measurement device 100 may evaluate a process performed on the substrate W to manufacture a semiconductor device, by irradiating the substrate W with input electron beams and detecting electrons emitted from the substrate W. The emitted electrons may be generated by, for example, elastic scattering or inelastic scattering, and various information may be acquired from the emitted electrons. For example, backscattered electrons may be generated by elastic scattering, and may have relatively high energy of approximately greater than or equal to 50 eV. The backscattered electrons may have information on a structural feature and composition in the vicinity of a surface of the substrate W. Secondary electrons may be generated by inelastic scattering, and may have relatively low energy of several eV. Secondary electrons may be emitted from an area very close to the surface of the substrate W (for example, an area having a depth of several nanometers) due to the relatively low energy of the secondary electrons. Thus, secondary electrons may have information related to roughness or microstructure in the vicinity of a surface of a substrate or a reference sample. Secondary electrons may be detected by a detector of the measurement device 100, and a measurement image may be formed based on a signal intensity of the secondary electrons. Accordingly, a fine surface structure of the substrate W may be obtained. Auger electrons may be generated by inelastic scattering, and may have information on chemical composition of the substrate and a bonding state in the vicinity of the surface of the substrate. X-rays may be emitted during inelastic scattering, and may be divided into continuum X-rays and characteristic X-rays. These X-rays may have information on elemental composition and chemical bonding of the substrate.

The measurement device 100 may include an electro-optical system 110, a detection unit 120, a measurement platform 130, and a processor 140.

The electro-optical system 110 may include an electron gun, a focusing lens, a deflector, and an objective lens. The electron gun may generate and emit input electron beams. The focusing lens may focus the input electron beams onto the deflector. The deflector may control a direction of the input electron beams to deflect the input electron beams such that a location which is set on the substrate W and/or the reference sample S is irradiated with the input electron beams. The objective lens may focus the input electron beams onto the substrate W and/or the reference sample S. Components of the electro-optical system 110 and a system for transmitting the input electron beams by using the components are not limited to the example described above, and other components may be added, or some of the components may be changed or omitted.

The detection unit 120 may detect at least a part of the emitted electrons that are emitted from the substrate W and/or the reference sample S. For example, the detection unit 120 may detect secondary electrons and/or backscattered electrons that are emitted from the substrate W and/or the reference sample S. The detection unit 120 may convert the emitted electrons that are detected into an electrical signal.

The measurement platform 130 may include a stage 132 and a reference sample support 134. The stage 132 may support the substrate W that is a measurement target, and the reference sample support 134 may support the reference sample S that is a measurement target. The reference sample support 134 may be provided around the stage 132. For example, referring to FIG. 2, the reference sample support 134 may be provided on one side of the stage 132.

The measurement platform 130 may move the substrate W in a horizontal direction (an X direction and/or a Y direction) or rotate the substrate W and/or the reference sample S around an axis in a vertical direction (a Z direction) such that the substrate W and/or the reference sample S are aligned with respect to the electro-optical system 110 that transmits the input electron beams.

In this specification, a direction parallel to an upper surface of the stage 132 is defined as a horizontal direction (an X direction and/or a Y direction), and a direction perpendicular to the horizontal direction (the X direction and/or the Y direction) is defined as a vertical direction (a Z direction).

Referring to FIG. 3, the processor 140 may include an image processing unit 142, an image reconstruction unit 144, and a measurement control unit 146.

The image processing unit 142 may receive the electrical signal detected by the detection unit 120, and generate an image. For example, the image processing unit 142 may receive the electrical signal corresponding to the emitted electrons that are emitted from a measurement area (for example, an area around an alignment mark) of the substrate W from the detection unit 120, and generate a measurement image of the substrate W based on the electrical signal.

The image processing unit 142 may determine whether an alignment mark is identified in the measurement area. In an example where an alignment mark is identified, the image processing unit 142 may determine location information of the alignment mark in the corresponding measurement area, and transmit the location information to the measurement control unit 146. The measurement control unit 146 may control the measurement platform 130 by using the location information of the alignment mark. Thereby, the location of the substrate W may be adjusted. In an example where an alignment mark is not identified in the measurement area, the image processing unit 142 may transmit the corresponding measurement image to the image reconstruction unit 144 to reconstruct or correct the image.

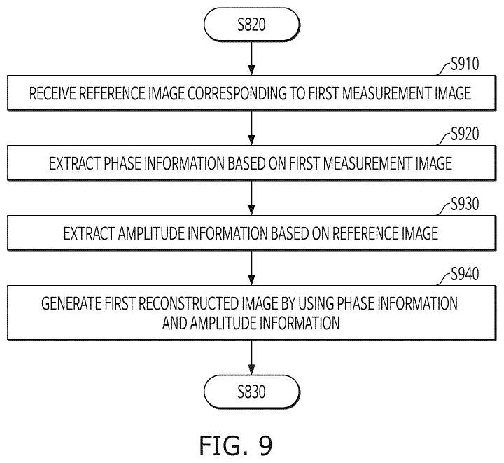

The image reconstruction unit 144 may reconstruct or correct the measurement image in which it is difficult to identify an alignment mark. For example, the image reconstruction unit 144 may reconstruct the measurement image by using a reference image acquired by measuring the reference sample S. For example, the image reconstruction unit 144 may extract phase information from the measurement image, and extract amplitude information from the reference image. The image reconstruction unit 144 may generate a reconstructed image by combining the extracted phase information and the extracted amplitude information. The image reconstruction unit 144 may determine location information of the alignment mark based on the reconstructed image, and transmit the location information of the alignment mark to the measurement control unit 146 to perform alignment of the substrate W. An example method by which the image reconstruction unit 144 reconstructs or corrects the image will be described in detail with reference to FIGS. 9 to 13.

The measurement control unit 146 may be configured to control each optical element included in the measurement device 100. For example, the measurement control unit 146 may be configured to generate signals for controlling driving of the electron gun, an operation of the focusing lens, an operation of the deflector, and an operation of the objective lens.

The measurement control unit 146 may control the electro-optical system 110 or the detection unit 120 by using measurement condition data. For example, the measurement control unit 146 may adjust a focal length, magnification, or an angle of the input electron beam in the electro-optical system 110 based on measurement condition data including parameters such as a size of the image, the number of pixels of the image, and a measurement angle of the image. The measurement control unit 146 may adjust a sensitivity of collection of the emitted electrons or a detection angle of the emitted electrons.

The measurement control unit 146 may control the measurement platform 130 to perform alignment of a measurement target object (for example, the substrate W or the reference sample S). For example, the measurement control unit 146 may align the measurement target object on the measurement platform 130 with respect to the electro-optical system 110 by moving the measurement platform 130 in the horizontal direction (the X direction and/or the Y direction) or rotating the measurement target object around an axis in the vertical direction (the Z direction).

An internal configuration of the processor 140 illustrated in FIG. 3 may be only an example, and may be implemented to be different from the configuration. For example, at least a part of the configuration of the processor 140 may be omitted, or other configurations may be added. The functions of each of the image processing unit 142, the image reconstruction unit 144, and the measurement control unit 146 may be combined or divided. In one or more other embodiments, at least some of operations or processes performed by the processor 140 may be performed by another component (for example, a processor or the like of another device that is communicatively connected to the measurement device 100).

The processor 140 may be a computing device, such as a workstation computer, a desktop computer, a laptop computer, a tablet computer, or a component thereof. The processor 140 may be configured with separate hardware, or may be separate software included in a single piece of hardware. The processor 140 may be a simple controller, a complex processor such as a microprocessor, a central processing unit (CPU), or a graphical processing unit (GPU), a processor configured by software, dedicated hardware, or firmware. The processor 140 may be implemented by, for example, a general-purpose computer or application-specific hardware such as a digital signal processor (DSP), a field programmable gate array (FPGA), and an application specific integrated circuit (ASIC).

According to one or more embodiments, operations of the processor 140 may be implemented as instructions that are stored in a computer-readable medium and are read and executed by one or more processors. For example, the computer-readable medium may include any mechanism for storing and/or transmitting information in a form that can be read by a machine (for example, a computing device). For example, the computer-readable medium may include a read only memory (ROM), a random access memory (RAM), a magnetic disk storage medium, an optical storage medium, and a flash memory device, and may store an electrical signal, an optical signal, an acoustic signal, a radio signal in another form (for example, a carrier wave signal, an infrared signal, a digital signal, or the like), and any other signals.

The processor 140 may execute firmware, software, routines, and instructions for causing the processor 140 to perform operations or any process to be described below. In one or more embodiments, the configuration may be for convenience of explanation, and it should be understood that operations of the processor 140 may be performed by a computing device, a processor, a controller, or another device that executes firmware, software, routines, instructions, or the like.

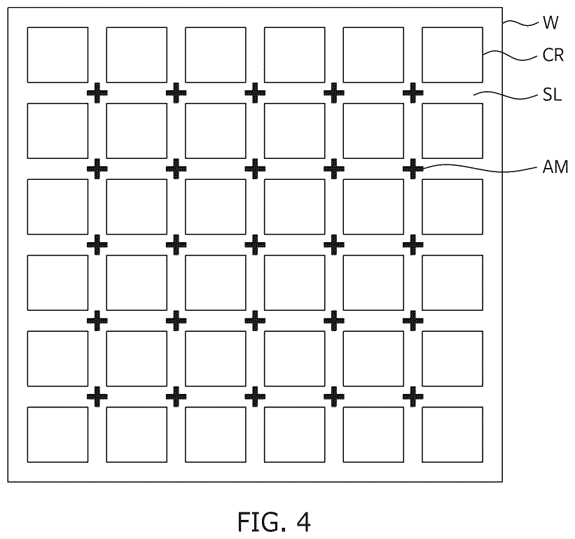

FIG. 4 is a schematic plan view of the substrate in FIG. 1. FIG. 4 may be understood as illustrating a partial area of the substrate W. The substrate W may have a shape of a circular plate.

Referring to FIG. 4, the substrate W may include a plurality of chip areas CR and scribe lines SL between the plurality of chip areas CR. In each of the plurality of chip areas CR, elements for implementing a semiconductor chip may be formed. The scribe line SL may be an area to separate the plurality of chip areas CR from each other. For example, the plurality of chip areas CR may be arranged to be spaced apart from each other by the scribe lines SL. The chip area CR may be referred to as a die.

An alignment mark AM may be formed on the scribe line SL. The alignment mark AM may be used to determine an alignment state of the substrate W in the measurement device (for example, 100 in FIG. 1). Location information of elements formed in the plurality of chip areas CR may be more accurately measured by using the alignment marks AM. The measurement device may be configured to recognize an alignment location and a direction of the substrate W by identifying a pattern of the alignment marks, and to correct an alignment error. The alignment mark AM may be referred to as an alignment key.

A plurality of alignment marks AM may be arranged to be spaced apart from each other at a constant interval on the scribe lines SL. For example, each of the plurality of alignment marks AM may be arranged at a center of four chip areas CR that are arranged to be adjacent to each other. For example, four chip areas CR may be arranged around the alignment mark AM. However, embodiments are not limited thereto. Each of the plurality of alignment marks AM may be arranged at an appropriate location to more accurately determine the alignment state of the substrate W.

The alignment mark AM may have, for example, a cross pattern. However, embodiments are not limited thereto, and the alignment mark AM may have various patterns. For example, the alignment mark AM may have an elongated bar pattern. The alignment mark AM may include a plurality of bar patterns. For example, the alignment mark AM may include a plurality of bar patterns extending in one direction parallel to the surface of the substrate W. In another example, the alignment mark AM may be a combination of a plurality of bar patterns extending in different directions.

A measurement image of the alignment mark AM that is measured by using the measurement device (for example, 100 in FIG. 1) may be acquired. The measurement image may be used to determine the alignment state of the substrate W. In one or more embodiments, the alignment mark AM in the measurement image may not be identified due to various causes. For example, in an example where the signal intensity of the emitted electrons is insufficient, the signal intensity being detected by the detector (for example, 120 in FIG. 1) of the measurement device, a measurement image with a low signal-to-noise ratio (SNR) may be generated, and as a result, the alignment mark AM may not be identified.

According to one or more embodiments, it is possible to improve the signal-to-noise ratio of the measurement image by using the reference sample S. The reference sample S may include a pattern corresponding to the plurality of alignment marks AM and the chip areas CR adjacent to and/or around the alignment marks. For example, the processor (for example, 140 in FIG. 1) of the measurement device may acquire a measurement image of a measurement area of the substrate W. For example, the measurement area may include the alignment mark AM and/or the chip areas CR adjacent to and/or around the alignment mark AM. In one or more other embodiments, the processor may acquire a reference image of the reference sample S. The processor may extract phase information from the measurement image of the substrate W, and extract amplitude information from the reference image of the reference sample. Next, the processor may generate a reconstructed image in which the signal-to-noise ratio is improved by combining the phase information and the amplitude information. Thereby, the processor may identify the alignment mark by using the reconstructed image, and determine location information of the alignment mark. The determined location information of the alignment mark may be used to correct the alignment error of the substrate W.

According to one or more embodiments, the reference image of the reference sample S may include a pattern corresponding to the measurement image of the substrate W. For example, the measurement image may include a pattern of the alignment mark AM. The measurement image may include a pattern of the alignment mark AM having a cross shape. The measurement image may include an alignment mark AM rotated in one direction, for example, an alignment mark AM rotated by 45 degrees. Thereby, a matching recognition rate between the measurement image and the reference image may be improved. In another example, the measurement image of the substrate W may include a pattern of the chip area CR. The measurement image may include a pattern of a corner portion of the chip area CR. The measurement image may include a pattern of a corner portion of a chip area CR rotated in one direction, for example, a pattern of a corner portion of a chip area CR rotated by 45 degrees.

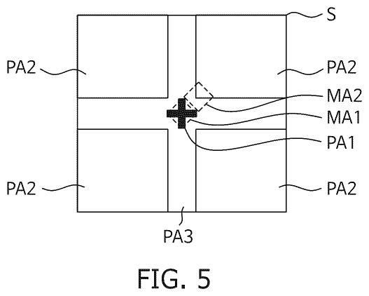

Hereinafter, the reference sample S will be described in detail with reference to FIGS. 5 to 7.

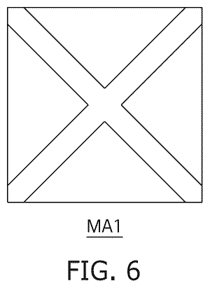

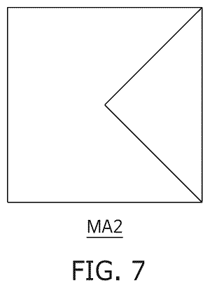

FIG. 5 is a schematic plan view of the reference sample in FIG. 1. FIGS. 6 and 7 are examples of the reference image according to one or more embodiments of the present disclosure.

The reference sample S may include a pattern corresponding to the alignment mark (for example, AM in FIG. 4) of the substrate (for example, W in FIG. 1) and the chip areas adjacent to and/or around the alignment mark (for example, CR in FIG. 4).

Referring to FIG. 5, the reference sample S may include a first pattern PA1, a second pattern PA2, and a third pattern PA3. The first pattern PA1 may have a pattern corresponding to the alignment mark of the substrate. The second pattern PA2 may include a pattern corresponding to at least a portion of the chip area arranged around the alignment mark. A plurality of second patterns PA2 may be arranged adjacent to and/or around the first pattern PA1. The third pattern PA3 may include a pattern corresponding to at least a portion of the scribe area of the substrate. The first pattern PA1 may be arranged on the third pattern PA3, and the plurality of second patterns PA2 may be arranged to be separated and spaced apart from each other by the third pattern PA3.

The reference sample S may be measured by the measurement device (for example, 100 in FIG. 1). Each of the patterns PA1, PA2, and PA3 of the reference sample S may be measured to be visually and more clearly distinguished. For example, the reference image acquired by measuring the reference sample S may have a relatively high signal-to-noise ratio. The reference sample S may include, for example, silicon, metal materials, or other materials that may be used in semiconductor manufacturing processes. In one or more embodiments, each of the patterns PA1, PA2, and PA3 of the reference sample S may have a height difference between the patterns. For example, each of the patterns PA1, PA2, and PA3 may have a step of several tens of nanometers.

In one or more embodiments, the reference image may be acquired by measuring at least a portion of the reference sample S. For example, referring to FIGS. 5 and 6, the reference image may be an image acquired by measuring a first reference measurement area MA1 of the reference sample S. The first reference measurement area MA1 may include a reference pattern corresponding to the shape of the alignment mark of the substrate (for example, a shape obtained by rotating the cross shape in one direction). In another example, referring to FIGS. 5 and 7, the reference image may be an image acquired by measuring a second reference measurement area MA2 of the reference sample S. The second reference measurement area MA2 may include a reference pattern corresponding to the shape of the chip area (for example, a shape obtained by rotating a corner portion of the chip area in one direction).

As described above, the shape of the reference sample S for acquiring the reference image and the shape of the reference pattern included in the reference image have been described. However, embodiments are not limited thereto. The reference image may include a pattern corresponding to the measurement image to reconstruct the measurement image of the substrate. The pattern (or shape) of the reference sample S, the shape of the reference pattern included in the reference image, and the like may have various patterns (or shapes).

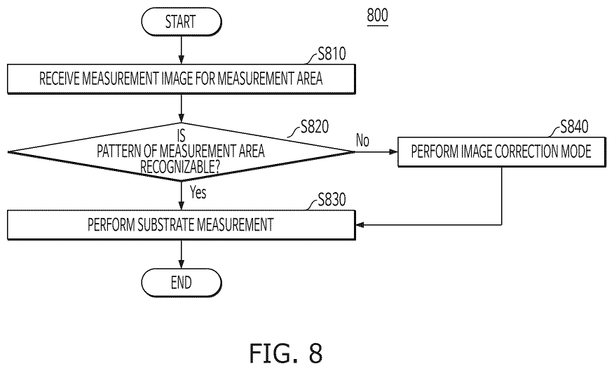

FIGS. 8 and 9 are flowcharts illustrating an example of a substrate measurement method according to one or more embodiments.

The substrate measurement method 800 may be performed by a processor (for example, 140 in FIG. 1) of the measurement device. However, embodiments are not limited thereto. The substrate measurement method 800 may be performed by a computing device (a processor of a computing device) connected to the measurement device.

The substrate measurement method 800 may be started in an example where the processor (the image processing unit) receives a first measurement image of a first measurement area on the substrate from the measurement device (S810). In one or more embodiments, the first measurement area may include at least one of the alignment mark or the chip area on the substrate. For example, the processor (the image processing unit) may receive a first measurement image of a first alignment mark among a plurality of alignment marks on the substrate. In one or more other embodiments, the processor (the image processing unit) may receive a first measurement image for at least a portion of a first chip area among a plurality of chip areas on the substrate.

In one or more embodiments, the measurement device may include an electron microscope. In one or more embodiments, the measurement image may be an image captured by using the electron microscope. In one or more other embodiments, the measurement device may include an optical microscope. In one or more other embodiments, the measurement image may be an image captured by using an optical microscope.

The processor (the image processing unit) may determine whether a pattern of the first measurement area is recognizable based on the first measurement image (S820). The processor (measurement control unit) may perform substrate measurement in an example where it is determined that the pattern of the first measurement area is recognizable (S830). For example, in an example where it is determined that the pattern of the first measurement area is recognizable, the processor (the image processing unit) may determine location information of the first measurement area. The processor (the measurement control unit) may correct the alignment error of the substrate and perform substrate measurement by using the determined location information of the first measurement area.

The processor (the image reconstruction unit) may perform an image correction mode in an example where it is determined that the pattern of the first measurement area is not recognizable (S840).

Referring to FIG. 9, the processor (the image reconstruction unit) may receive a reference image corresponding to the first measurement image (S910). The reference image may be a sample image captured by the measurement device or a drawing image created as reference data. For example, the processor (the image reconstruction unit) may receive a sample image acquired by capturing a sample related to the substrate. In one or more embodiments, the processor (the image reconstruction unit) may receive a drawing image related to the substrate.

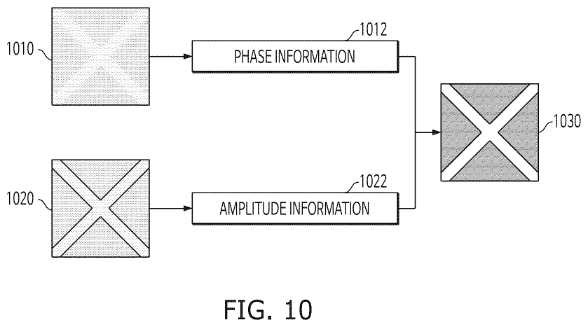

Next, the processor (the image reconstruction unit) may extract phase information based on the first measurement image (S920). In one or more embodiments, the processor (the image reconstruction unit) may extract amplitude information based on the reference image (S930). The processor (the image reconstruction unit) may generate a reconstructed image by using the phase information of the first measurement image and the amplitude information of the reference image (S940). The processor (the image reconstruction unit) may determine location information of the measurement area based on the reconstructed image acquired by performing the image correction mode. The processor (the measurement control unit) may correct the alignment error of the substrate and perform substrate measurement by using the location information of the first measurement area that is determined based on the reconstructed image. An example method of performing the image correction mode will be described in detail with reference to FIGS. 10 to 13.

In one or more embodiments, the first measurement image and the reference image may be images captured by using the same measurement device. For example, the first measurement image and the reference image may be captured by a single measurement device. For example, the first measurement image and the reference image may be images captured by using an electron microscope. In another example, the first measurement image and the reference image may be images captured by using an optical microscope. In still another example, the first measurement image and the reference image may be images captured by using a combination of an optical microscope and an electron microscope.

In one or more embodiments, the first measurement image and the reference image may be images captured by using the measurement device in which a predetermined measurement condition is set. The predetermined measurement condition may include at least one of the size of the image, the number of pixels in the image, or the measurement angle. However, embodiments are not limited thereto. The predetermined measurement condition may include various parameters which can be set such that the first measurement image and the reference image include the corresponding pattern or shape.

In one or more embodiments, the processor may receive a preliminary measurement image of the first measurement area on the substrate before receiving the first measurement image. The processor may set the measurement condition based on the preliminary measurement image.

In one or more embodiments, the processor may generate a die map of the substrate by using pieces of location information that are acquired from a plurality of areas including the first measurement area of the substrate. For example, the processor may acquire a second measurement image for a second measurement area on the substrate. For example, the second measurement image may be an original measurement image or a reconstructed image. The original measurement image may be a measurement image on which the image correction mode has not been performed, and may be a measurement image in which a pattern may be identified. In an example where the second measurement image is a reconstructed image, a process of acquiring a second reconstructed image may be substantially identical to the process of acquiring the first reconstructed image described above. The processor may determine location information of the second measurement area based on the second measurement image. The processor may generate a die map of the substrate based on the location information of the first measurement area and the location information of the second measurement area.

The flowcharts of FIGS. 8 and 9 and the above description are examples, and embodiments are not limited thereto. For example, at least some of the steps in the method may be added/changed/deleted, or the order of at least some of the steps in the method may be changed.

FIG. 10 is a diagram for explaining a method of generating a reconstructed image according to one or more embodiments.

The method of generating a reconstructed image may be performed by the processor (for example, 140 in FIG. 1) of the measurement device. However, embodiments are not limited thereto. The method of generating a reconstructed image may be performed by a computing device (a processor of a computing device) connected to the measurement device.

The processor (the image reconstruction unit) may generate a reconstructed image 1030 by using a measurement image 1010 acquired by measuring the substrate and a reference image 1020 acquired by measuring the reference sample. For example, the processor (the image reconstruction unit) may generate a reconstructed image 1030 by using phase information 1012 of the measurement image 1010 and amplitude information 1022 of the reference image 1020.

In one or more embodiments, the processor (the image reconstruction unit) may convert spatial domain information of each of the measurement image 1010 and the reference image 1020 into frequency domain information by performing Fourier transform. A result obtained by performing Fourier transform may be expressed as a complex number. A magnitude component of the complex number may represent amplitude information, and an angular component of the complex number may represent phase information.

The processor (the image reconstruction unit) may extract phase information 1012 from the frequency domain information of the measurement image 1010. The phase information 1012 may be determined by acquiring the angular component of the complex number acquired by performing Fourier transform. The phase information 1012 may represent information on a structure of the image, and a shape or a boundary of the image may be mainly maintained by the phase information of the image.

The processor (the image reconstruction unit) may extract amplitude information 1022 from the frequency domain information of the reference image 1020. The amplitude information 1022 may be determined by acquiring the magnitude component of the complex number acquired by performing Fourier transform. The amplitude information 1022 may be divided into low-frequency components that represent the overall shape or change of the image and high-frequency components that represent details or boundaries of the image.

The processor (the image reconstruction unit) may generate a reconstructed image 1030 by combining the phase information 1012 and the amplitude information 1022 to generate reconstructed frequency domain information and converting the reconstructed frequency domain information into reconstructed spatial domain information. The reference image 1020 more clearly expresses boundaries or outlines of the pattern, and thus, the processor (the image reconstruction unit) may generate a reconstructed image 1030 in which the signal-to-noise ratio is improved by using the amplitude information of the reference image 1020.

In FIG. 10, the reference image 1020 may be illustrated as an image including an alignment mark having a cross shape (an alignment mark rotated by 45 degrees). However, embodiments are not limited thereto. The reference image 1020 may include various patterns described with reference to FIGS. 4 and 5.

The flowchart of FIG. 10 and the above description are examples, and embodiments are not limited thereto. For example, at least some of the steps in the method may be added/changed/deleted, or the order of at least some of the steps in the method may be changed.

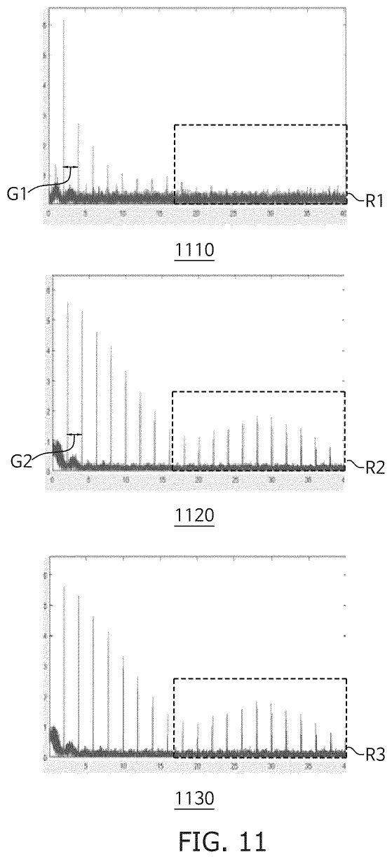

FIG. 11 is a diagram illustrating examples of a first frequency domain 1110, a second frequency domain 1120, and a third frequency domain 1130 for each of the measurement image 1010, the reference image 1020, and the reconstructed image 1030. The first frequency domain 1110 may represent the frequency domain of the measurement image 1010, and the second frequency domain 1120 may represent the frequency domain of the reference image 1020. Further, the third frequency domain 1130 may represent the frequency domain of the reconstructed image 1030.

The first frequency domain 1110 may include a first area R1, the second frequency domain 1120 may include a second area R2, and the third frequency domain 1130 may include a third area R3. The first to third areas R1, R2, and R3 may represent arbitrary frequency ranges that correspond to each other in the frequency domains 1110, 1120, and 1130. Referring to FIG. 11, noise may be mainly distributed in the first area R1 of the first frequency domain 1110, whereas amplitude peaks may be confirmed in the second area R2 of the second frequency domain 1120 and the third area R3 of the third frequency domain 1130. Thereby, it may be confirmed that a signal quality of the reconstructed image 1030 is improved by using the amplitude information of the reference image 1020.

The signal quality of the reconstructed image 1030 may be greater than the signal quality of the measurement image. For example, the reconstructed image 1030 may include the amplitude information 1022 of the reference image 1020 having a relatively high signal-to-noise ratio, and thus, the signal-to-noise ratio of the reconstructed image 1030 may be greater than the signal-to-noise ratio of the measurement image 1010.

According to one or more embodiments, intervals between the amplitude peaks in each of the frequency domain 1110 of the measurement image 1010 and the frequency domain 1120 of the reference image 1020 may correspond to each other. For example, an interval G1 between first amplitude peaks in the first frequency domain 1110 may correspond to an interval G2 between second amplitude peaks in the second frequency domain 1120. The intervals G1 and G2 between the amplitude peaks corresponding to each other may indicate that there are sections in which the frequency components of the measurement image 1010 and the reference image 1020 match with each other. Thus, the reconstructed image 1030 in which the signal-to-noise ratio is improved may be acquired.

The values in FIG. 11, for example, the frequency ranges in each of the first to third areas R1, R2, and R3 are examples for explanation, but embodiments are not limited thereto.

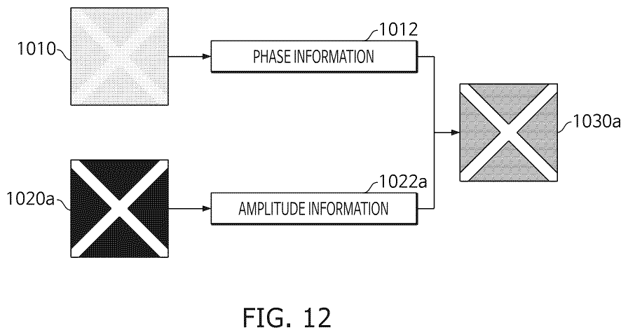

FIG. 12 is a diagram for explaining a method for generating a reconstructed image according to one or more embodiments.

In one or more embodiments, the reference image 1020a may be an artificial drawing image related to the substrate. The reference image 1020a may not have noise caused by measurement environment factors or devices. Thus, the reference image 1020a may have almost no noise. Thereby, the signal-to-noise ratio of the reference image 1020a may be greater than the signal-to-noise ratio of the measurement image 1010. The example of the method of generating a reconstructed image that is to be described in FIG. 12 may be substantially identical to the method of generating a reconstructed image described with reference to FIG. 10, except that the reference image 1020a is a drawing image.

The processor (the image processing unit) may acquire a drawing image related to the substrate. For example, the processor (the image processing unit) may acquire a drawing image including a pattern corresponding to the measurement image 1010 from among a plurality of drawing images that are stored in advance. For example, the center coordinates of the patterns (intersections of the scribe area patterns) in each of the measurement image 1010 and the reference image 1020a may substantially correspond to each other. The acquired drawing image may be used as the reference image 1020a to improve the signal quality of the measurement image 1010. In FIG. 12, the reference image 1020a may be illustrated as an image including an alignment mark having a cross shape (an alignment mark rotated by 45 degrees). However, embodiments are not limited thereto. The reference image 1020a may include various patterns described with reference to FIGS. 4 and 5.

The processor (the image reconstruction unit) may convert spatial domain information of the reference image 1020a into frequency domain information by performing Fourier transform. The processor (the image reconstruction unit) may extract amplitude information 1022a from the frequency domain information of the reference image 1020a. The processor (the image reconstruction unit) may generate a reconstructed image 1030a by combining the phase information 1012 and the amplitude information 1022a to generate reconstructed frequency domain information and converting the reconstructed frequency domain information into reconstructed spatial domain information.

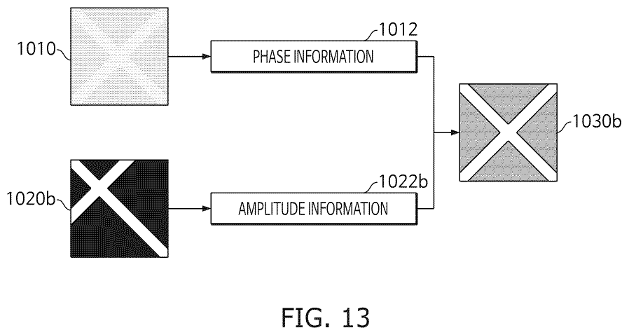

FIG. 13 is a diagram for explaining a method of generating a reconstructed image according to one or more embodiments.

In one or more embodiments, the reference image 1020b may be an artificial drawing image related to the substrate. The example of the method of generating a reconstructed image that is to be described in FIG. 13 may be substantially identical to the method of generating a reconstructed image described with reference to FIG. 10, except that the reference image 1020b is a drawing image. Further, the method of generating a reconstructed image that is to be described in FIG. 13 may be substantially identical to the method of generating a reconstructed image described with reference to FIG. 12, except that the center coordinates of the patterns (the intersection of the scribe area patterns) are different in each of the measurement image 1010 and the reference image 1020b.

The processor (the image processing unit) may acquire a drawing image including a pattern corresponding to the measurement image 1010 from among a plurality of drawing images that are stored in advance. The center coordinate of the pattern included in the acquired drawing image may be different from the center coordinate of the pattern included in the measurement image 1010.

The processor (the image reconstruction unit) may convert spatial domain information of the reference image 1020b into frequency domain information by performing Fourier transform. The processor (the image reconstruction unit) may extract amplitude information 1022b from the frequency domain information of the reference image 1020b. The processor (the image reconstruction unit) may generate a reconstructed image 1030b by combining the phase information 1012 and the amplitude information 1022b to generate reconstructed frequency domain information and converting the reconstructed frequency domain information into reconstructed spatial domain information.

The reference image 1020b, which is a drawing image, may have almost no noise, and thus, the shape and the center coordinate of the pattern from the reference image 1020b may be extracted. Further, the reconstructed image 1030b may be generated by using only the amplitude information of the reference image 1020b even in an example where the center coordinates of the patterns are different. Thus, a relatively high signal quality may be maintained.

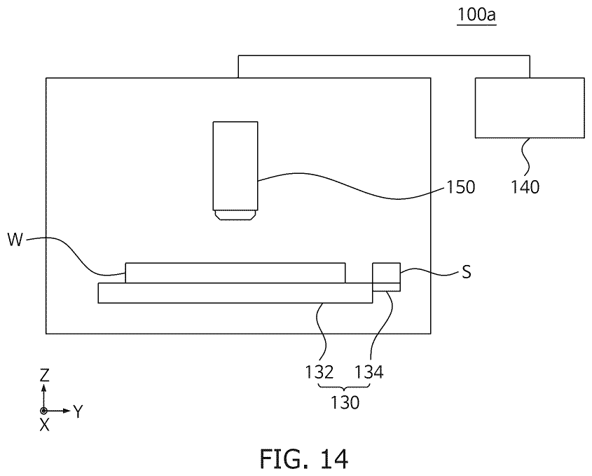

FIG. 14 is a schematic diagram illustrating a measurement device according to one or more embodiments.

In one or more embodiments, the measurement device 100a may be an optical microscope. The example of the measurement device 100a illustrated in FIG. 14 may be substantially identical to the measurement device 100 described with reference to FIGS. 1 to 13, except that the measurement device 100a is an optical microscope. A processor 140 of the measurement device 100a may perform the method of generating a reconstructed image described with reference to FIGS. 1 to 13.

Referring to FIG. 14, the measurement device 100a may include an optical system 150, a measurement platform 130, and a processor 140. The optical system 150 may include a light source, a focusing lens, a deflector, an objective lens, and an optical detection unit.

The light source may irradiate the substrate W with light, and the focusing lens may focus the light for irradiation onto the deflector. The deflector may deflect the light by controlling a direction of the light such that a location which is set on the substrate W and/or the reference sample S is irradiated with the light. The objective lens may focus the light onto the substrate W and/or the reference sample S. The optical detection unit may detect light reflected or transmitted from the substrate W and/or the reference sample S, and convert an optical signal into an electrical signal. For example, the optical detection unit may include an image sensor, and detect a minute change or adjustment on the surface of the substrate W and/or the reference sample S. Components of the optical system 150 and the light transmission system using the components are not limited to the example described above, and other components may be added, or some of the components may be changed.

The measurement platform 130 may support the substrate W and the reference sample S, and may adjust a location of the substrate W by moving or rotating the substrate W such that the substrate W is aligned with respect to the optical system 150.

The processor 140 may derive information on a shape and a structure of the substrate by processing the image based on the optical signal or analyzing reflected light. The processor 140 may be involved in the overall control and data processing of the measurement device 100a, and may control a movement of the measurement platform 130 or generate an image of the substrate W based on data collected from the detection unit 120. In one or more embodiments, the processor 140 may perform measurement on the substrate W by using the optical system 150, and generate a reconstructed image of the measurement image.

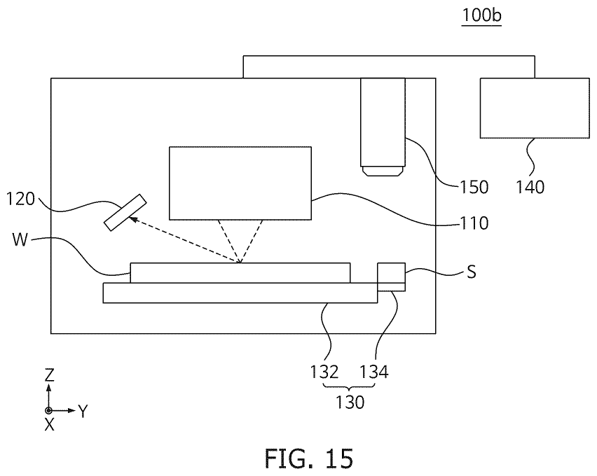

FIG. 15 is a schematic diagram illustrating a measurement device according to one or more embodiments.

In one or more embodiments, the measurement device 100b may be a measurement device including an electro-optical system 110 and an optical system 150. The example of the measurement device 100b illustrated in FIG. 15 may be substantially identical to the measurement device 100 or 100a described with reference to FIGS. 1 to 14, except that the measurement device 100b is a measurement device including an electro-optical system 110 and an optical system 150. A processor 140 of the measurement device 100b may perform the method of generating a reconstructed image described with reference to FIGS. 1 to 13.

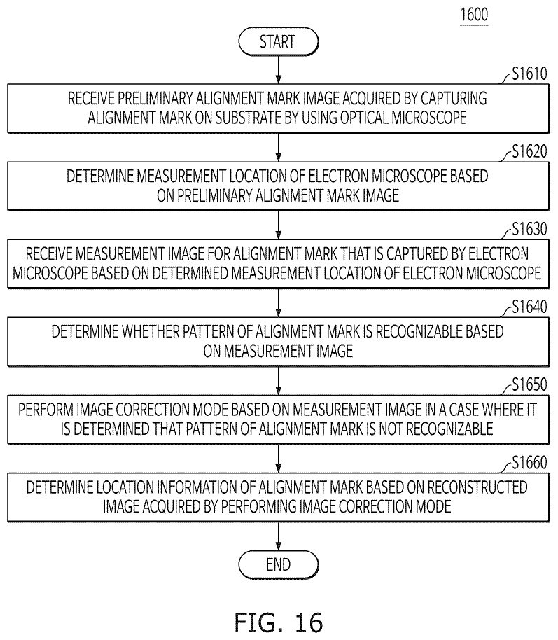

In one or more embodiments, the processor 140 may perform measurement on the substrate W by using the electro-optical system 110 and the optical system 150, and generate a reconstructed image of the measurement image. Here, the electro-optical system 110 of the measurement device 100b may be referred to as an electron microscope, and the optical system 150 of the measurement device 100b may be referred to as an optical microscope. An example method of generating a reconstructed image by using the measurement device 100b will be described in detail with reference to FIG. 16.

FIG. 16 is a flowchart illustrating an example of a substrate measurement method according to one or more embodiments of the present disclosure.

The substrate measurement method 1600 may be performed by a processor (for example, 140 in FIG. 15) of the measurement device. The example of the substrate measurement method that is to be described with reference to FIG. 16 may be substantially identical to the method described in FIGS. 1 to 13, except that the substrate measurement method is performed by using the measurement device (for example, 100b in FIG. 15) including an electron microscope and an optical microscope.

In one or more embodiments, the processor may start measurement in an example of receiving a preliminary alignment mark image acquired by capturing the alignment mark on the substrate by using the optical microscope (S1610). The processor may determine a measurement location of the electron microscope based on the preliminary alignment mark image (S1620). The processor may receive a measurement image for the alignment mark captured by the electron microscope based on the determined measurement location of the electron microscope (S1630). The processor may determine whether a pattern of the alignment mark is recognizable based on the measurement image (S1640). The processor may perform the image correction mode based on the measurement image in an example where it is determined that the pattern of the alignment mark is not recognizable (S1650). For example, the processor may receive a reference image corresponding to the measurement image from the electron microscope. The processor may extract phase information from the frequency domain information of the measurement image. The processor may extract amplitude information from the frequency domain information of the reference image. The processor may generate a reconstructed image by using the phase information of the measurement image and the amplitude information of the reference image.

The processor may determine location information of the alignment mark based on a reconstructed image acquired by performing the image correction mode (S1660).

The flowchart of FIG. 16 and the above description may be only examples, and the present disclosure is not limited thereto. For example, at least some of the steps in the method may be added/changed/deleted, or the order of at least some of the steps in the method may be changed.

While embodiments have been described with reference to the figures, it will be understood by those of ordinary skill in the art that various changes in form and details may be made therein without departing from the spirit and scope as defined by the following claims and their equivalents.

What is claimed is:

1. A substrate measurement method comprising:
acquiring a first measurement image corresponding to a first measurement area on a substrate;
acquiring a reference image corresponding to the first measurement image;
extracting phase information based on the first measurement image;
extracting amplitude information based on the reference image;
generating a first reconstructed image based on the phase information and the amplitude information; and
determining location information of the first measurement area based on the first reconstructed image.

2. The substrate measurement method of claim 1, wherein the extracting the phase information based on the first measurement image comprises:
converting spatial domain information of the first measurement image into frequency domain information, and
extracting the phase information from the frequency domain information of the first measurement image.

3. The substrate measurement method of claim 1, wherein the extracting the amplitude information based on the reference image comprises:
converting spatial domain information of the reference image into frequency domain information, and
extracting the amplitude information from the frequency domain information of the reference image.

4. The substrate measurement method of claim 1, wherein the generating the first reconstructed image comprises:
generating reconstructed frequency domain information by combining the phase information and the amplitude information; and
converting the reconstructed frequency domain information into reconstructed space domain information.

5. The substrate measurement method of claim 1, wherein the first measurement image and the reference image are images captured by a measurement device.

6. The substrate measurement method of claim 1, wherein the first measurement image and the reference image are images captured by a measurement device that is set under a predetermined measurement condition, and
wherein the predetermined measurement condition comprises at least one of a size of the image, a number of pixels in the image, or a measurement angle.

7. The substrate measurement method of claim 1, wherein the first measurement image is captured by an electron microscope.

8. The substrate measurement method of claim 1, wherein the first measurement image is captured by an optical microscope.

9. The substrate measurement method of claim 1, wherein a signal quality of the first reconstructed image is greater than a signal quality of the first measurement image.

10. The substrate measurement method of claim 1, further comprising:
acquiring a second measurement image corresponding to a second measurement area on the substrate;
determining location information of the second measurement area based on the second measurement image; and
generating a die map of the substrate based on the location information of the first measurement area and the location information of the second measurement area.

11. The substrate measurement method of claim 1, wherein the acquiring the first measurement image for the first measurement area on the substrate comprises:
acquiring the first measurement image corresponding to a first alignment mark among a plurality of alignment marks on the substrate.

12. The substrate measurement method of claim 1, wherein the acquiring the first measurement image for the first measurement area on the substrate comprises:
acquiring the first measurement image corresponding to at least a portion of a first chip area among a plurality of chip areas on the substrate.

13. The substrate measurement method of claim 1, wherein the acquiring the reference image corresponding to the first measurement image comprises:
acquiring a reference sample image by capturing a reference sample corresponding to the substrate.

14. The substrate measurement method of claim 1, wherein the acquiring the reference image corresponding to the first measurement image comprises:
acquiring a drawing image corresponding to the substrate.

15. The substrate measurement method of claim 1, wherein the reference image comprises a reference pattern corresponding to a shape of an alignment mark on the substrate.

16. The substrate measurement method of claim 1, wherein the reference image comprises a reference pattern corresponding to a shape of a chip area adjacent to an alignment mark on the substrate.

17. The substrate measurement method of claim 1, wherein an interval between adjacent amplitude peaks in frequency domain of the first measurement image corresponds to an interval between adjacent amplitude peaks in frequency domain of the reference image.

18. The substrate measurement method of claim 1, further comprising:
before the acquiring the first measurement image, acquiring a preliminary measurement image corresponding to the first measurement area on the substrate; and
setting a measurement condition based on the preliminary measurement image.

19. A substrate measurement method comprising:
acquiring a measurement image corresponding to a measurement area on a substrate by a measurement device;
determining whether a pattern of the measurement area is recognizable based on the measurement image;
performing an image correction based on a determination that the pattern of the measurement area is not recognizable; and
determining location information of the measurement area based on a reconstructed image acquired by performing the image correction, wherein
wherein the performing the image correction comprises:
acquiring a reference image corresponding to the measurement image,
extracting phase information based on the measurement image,
extracting amplitude information based on the reference image, and
generating the reconstructed image based on the phase information and the amplitude information.

20. A substrate measurement method comprising:
acquiring a preliminary alignment mark image by capturing an alignment mark on a substrate using an optical microscope;
determining a measurement location of an electron microscope based on the preliminary alignment mark image;
acquiring a measurement image for the alignment mark by capturing the alignment mark using the electron microscope based on the determined measurement location of the electron microscope;
determining whether a pattern of the alignment mark is recognizable based on the measurement image;
performing an image correction based on a determination that the pattern of the alignment mark is not recognizable; and
determining location information of the alignment mark based on a reconstructed image acquired by performing the image correction,
wherein the performing the image correction comprises:
acquiring a reference image corresponding to the measurement image by the electron microscope,
extracting phase information from frequency domain information of the measurement image,
extracting amplitude information from frequency domain information of the reference image, and
generating the reconstructed image based on the phase information and the amplitude information.
